(19) United States
(12) Patent Application Publication
(10) Pub. No.: US 2014/0040566 A1
(43) Pub. Date: Feb. 6, 2014

(54) METHOD AND SYSTEM FOR ACCESSING C++ OBJECTS IN SHARED MEMORY

(71) Applicant: Boris Burshteyn, Walnut Creek, CA (US)

(72) Inventor: Boris Burshteyn, Walnut Creek, CA (US)

(21) Appl. No.: 13/956,595

(22) Filed: Aug. 1, 2013

Related U.S. Application Data
(60) Provisional application No. 61/678,500, filed on Aug. 1, 2012.

(51) Int. Cl. G06F 12/10

(52) U.S. Cl. CPC G06F 12/1072
USPC 711/147

(57) ABSTRACT

The current application discloses methods and systems that access member functions and data fields of C++ objects placed in shared memory as well as cast such objects from multiple processes. The method employs basic C++ operations and guarantees correct access for any C++ translator. The method calculates the offsets to the data fields of each C++ class at the time of access. For that calculation to be correct, each process uses dedicated C++ objects of the same class placed in the process's own process heap. Because of their location, these dedicated objects allow for regular C++ access since the runtime uses the vtable for a process to access process-heap objects. For objects placed in shared memory, the runtime accesses data fields through specially constructed C++ expressions that add the calculated offsets to the object address. For member functions, an additional mechanism is involved that invokes each member function on the dedicated object from the process heap, passing auxiliary parameters to the function. These parameters include the address of the objects in shared memory and address of the object in heap memory. The addresses are used inside the function in order to further access object data fields and member functions. Casting uses dedicated objects in order to calculate offsets between super-object and sub-object.

### CROSS-REFERENCE TO RELATED APPLICATION

This application claims the benefit of Provisional Application No. 61/678,500, filed Aug. 1, 2012.

### TECHNICAL FIELD

The current application is directed to computer systems and, in particular, to a method by which multiple computational processes can access an object stored in shared memory.

### BACKGROUND

The C++ object model allows for multiple virtual inheritance from base classes by derived classes. The C++ object model also allows for overriding of virtual member functions of base classes by member functions of classes derived from the base classes. In order to call member functions efficiently, a typical C++ translator generates a specific table of addresses for each C++ class called the virtual table, or vtable, containing addresses of base-class member functions and/or derived-class member functions. The translator also inserts the address of the vtable in the layout of each generated C++ object. Typically this address is placed at the beginning of every instance of a C++ class, allowing for efficient runtime member-function invocation. For instances of the derived classes, the translator inserts vtable addresses for each of the base and derived classes. From the vtable addresses, generated machine code obtains the address of any given virtual member function from any of the base or derived classes. The vtable address and the contents of the vtable depend on the executable that created the table. Different executables may generate different vtable addresses and different vtable contents for instances of the same C++ classes.

For a program that accesses an object previously created by the program with the vtable address V1, the address V1 does not change at runtime. Therefore, the address V1 allows for correct access to the object's data and member functions. However, when a first program places an object in shared memory, other programs may not correctly access the object because they may expect the vtable to be located at a different address V2≠V1. Typically, such incorrect accesses result in a memory-access violation interrupting and aborting the program control flow. For some C++ translators, a similar problem also occurs when accessing data fields of the derived and based classes with multiple virtual inheritance. This happens because the runtime uses the vtable both to calculate addresses of member functions as well as offsets to data fields. In addition, a similar problem occurs when dynamically casting object pointers to either a super-object or a sub-object, because such casting involves the generated virtual tables.

Although some C++ translators claim to generate vtables in a way that allows any process to access any object, the C++ standard does not impose any specific requirement for correct access to C++ objects in shared memory. Therefore, applications that rely on such types of access become dependent on the C++ translator used for their particular builds. This situation is unacceptable for an application that is expected to be translatable by any C++ translator. For example, consider a translator T that translates a program from some programming language into C++ and that generates C++ code and data expected to work for multiple processes accessing generated C++ objects in shared memory. The translator T should generate code that any C++ translator is able to translate into correctly functioning machine code. However, when generating regular C++ code, the C++ code will not work when translated by some C++ translators.

### SUMMARY

The current application discloses methods and systems that access member functions and data fields of C++ objects placed in shared memory as well as cast such objects from multiple processes. The method employs basic C₊₊ operations and guarantees correct access for any C++ translator. The method calculates the offsets to the data fields of each C++ class at the time of access. For that calculation to be correct, each process uses dedicated C++ objects of the same class placed in the process's own process heap. Because of their location, these dedicated objects allow for regular C++ access since the runtime uses the viable for a process to access process-heap objects. For objects placed in shared memory, the runtime accesses data fields through specially constructed C++ expressions that add the calculated offsets to the object address. For member functions, an additional mechanism is involved that invokes each member function on the dedicated object from the process heap, passing auxiliary parameters to the function. These parameters include the address of the objects in shared memory and address of the object in heap memory. The addresses are used inside the function in order to further access object data fields and member functions. Casting uses dedicated objects in order to calculate offsets between super-object and sub-object.

### BRIEF DESCRIPTION OF THE DRAWINGS

FIG. 1 illustrates a hierarchy of classes involving multiple inheritance with virtual bases.

FIG. 2 shows object layouts for instances of the classes of Example 1.

FIG. 3 schematically shows an example of access violation where process P2 accesses instance created by process P1 in shared memory.

FIG. 4 shows how to rewrite a regular C++ member-function using the disclosed technique.

FIG. 5 shows how to rewrite a regular call to a C++ virtual member-function using the disclosed technique.

FIG. 6 shows the class hierarchy of O, O1 and O2.

FIG. 7 shows how to rewrite a regular call to a C++ virtual member-function using the disclosed technique.

FIG. 8 shows an example of the original and the augmented C++ classes.

FIG. 9 illustrates a general virtual method call.

FIG. 10 shows graphically relations between a dedicated object and its sub-objects and the offsets calculated according to the disclosed method.

FIG. 11 illustrates the disclosed casting method.

FIG. 12 shows a new template method.

FIG. 13 illustrates conversion for C++ down-casts of objects from shared memory:

FIG. 14 illustrates conversion for C++ up-casts of objects from shared memory.

### DETAILED DESCRIPTION

The currently disclosed methods and systems are described, below, in a number of examples.

### 1. Example of a Shared Object Access Violation

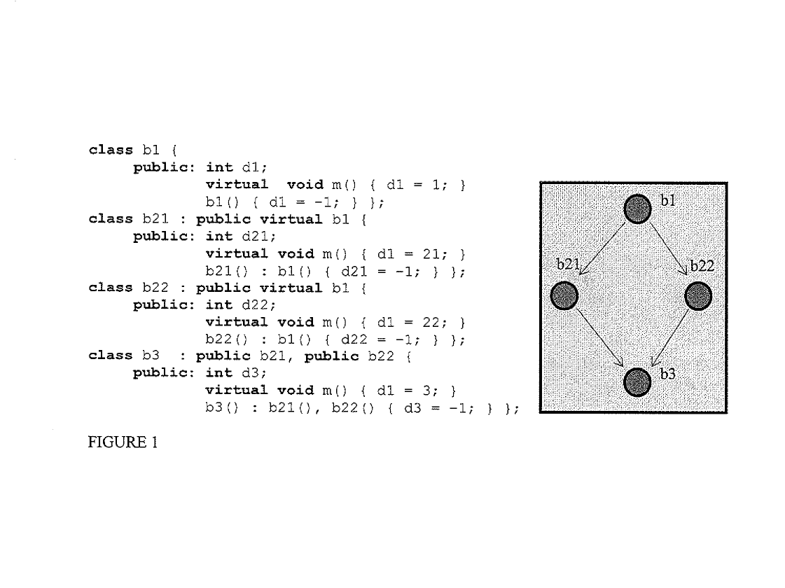

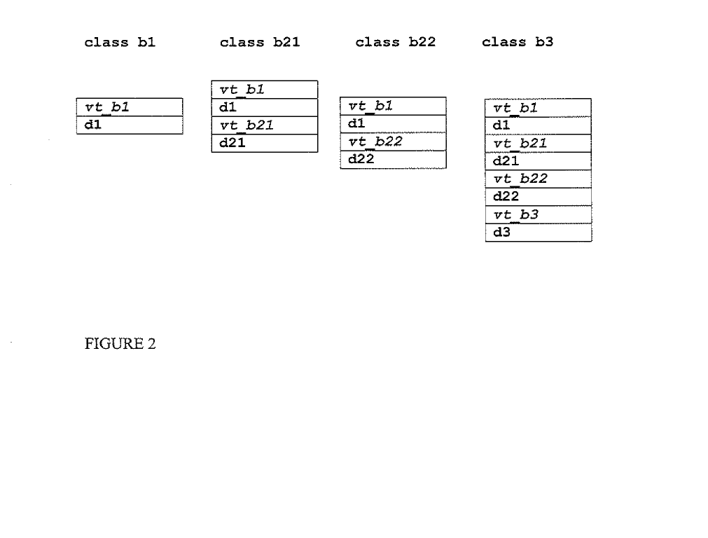

The following example illustrates the problem of accessing C++ objects located in shared memory. Consider the hierarchy of classes involving multiple inheritance with virtual bases, illustrated in FIG. 1. A C++ translator may generate a layout for instances of the above classes in various ways. For example, as tested with CYGWIN GNU C++ translator, the translator could place viable addresses at the beginning of each instance followed by the int data fields, so that the respective object layouts appear as shown in FIG. 2. The addresses at each of the pointers vt_b* refer to the address space of the process where the virtual tables are located. This happens whether a particular instance of a class is created on the heap of the process or in a piece of shared memory. Therefore, when an instance created by a process P1 is accessed by a process P2, an access violation occurs when the process P2 has virtual tables located at different addresses in its process memory than the addresses of virtual tables used by process P1. Also, the problem might happen regardless of the location of the executable code generated by the translator: either in the virtual memory of the executable binary or in the virtual memory of a shared library. The problematic access occurs in several basic C++ operations:
When getting or setting an object data field such as p3−>d3,
When invoking a member function of an object, such as p3−>m ( ),
When dynamically casting an object pointer to an address of either super- or sub-object such as dynamic_cast<b3*>(p22) or dynamic_cast<b22 *>(p3),
When using a pointer to a member function such as &b22::m.

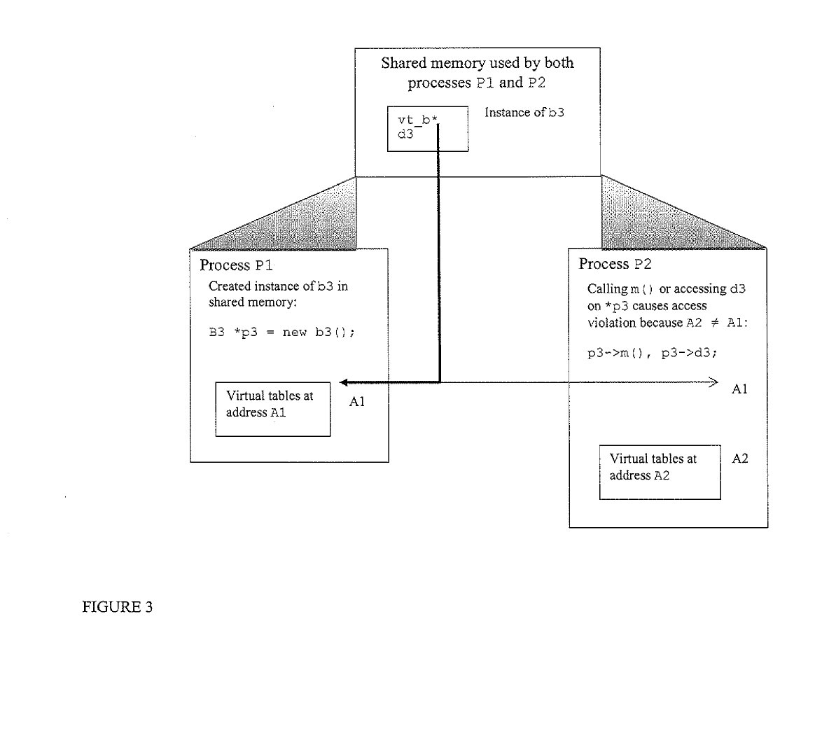

FIG. 3 schematically shows an example of access violation where process P2 accesses instance created by process P1 in shared memory.

Solution to Scenario of Example 1

According to the current application, auxiliary data and special code is used for accessing shared objects instead of the direct manipulation of C++ expressions such as p3−>m ( ) or p3−>d3. For applications that use a special translator in order to convert their source code into C++ automatically, that special translator can generate the proposed auxiliary data and the special access code. For applications which are manually coded in C++ language, the programmers can architect and implement these applications using the proposed data organization and special patterns of coding.

The auxiliary data consists of two parts. The first is a set of dedicated objects created for each C++ class at the startup of a process in the process heap. These objects direct the runtime code to choose correct offsets to the fields and member functions of objects from shared memory, created by the process or by other processes. When the type of any C++ object from shared memory is known at compile time, it is possible to use these heap objects in order to access each field and each method of the shared objects. When the types of heap objects are not known at compile time, each C++ class is augmented with an integral field that assists in this mechanism. The scheme works with any C++ compiler, despite any peculiarities in its generated virtual tables, as long as the compiler guarantees the following properties of the generated runtime objects and virtual tables:
The offsets from the beginning of every object to each field in the object is the same for a given class regardless of whether the object is created on the heap or in shared memory and by which process the object was created.
The offsets from the beginning of every object to its sub-objects corresponding to base classes are the same for a given class regardless of whether the object is created on the heap or in shared memory and by which process the object was created.
   The above set of conditions is practically guaranteed by standard compliant C++ translators.

As mentioned above, the solutions differ depending on the knowledge of the type of an object in shared memory. First, a static case is described involving a pointer p to an object o of class O when it is known that o is a part of another object o1 of class O1 derived from class O. Knowing this fact allows for using the class name O1 in the C++ expressions that are used to access fields and member-functions from object o. Then, a dynamic case is described in which the class of the containing object o1 is unknown at compile time. Each class is instrumented with an additional field containing an index of the class O1 that is used at runtime in order to access the heap-allocated objects. The C++ expressions used for that access are similar to the static case, although they employ runtime indexes instead of statically known class names.

### Field Access

The field access mechanism is based on the fact that each C++ object of a given class O has fields laid out the same way regardless of whether the object is created on the heap or in shared memory and by which process the object was created. In other words, for every field O::f from a class O the offset off (f) from the object address to the field address is the same for any object o of the class O. Therefore, it is possible to access f efficiently using C++ expression:

*(F *) ((char *)&o+off(f))

This works regardless of where object o resides. Therefore, only the value off (f) is used in order to provide access to the field f. However, this value may not be calculated at the time of the access using the same object o when o is in shared memory because a runtime error may occur in the case that the accessing process did not create o. Therefore, for each class O, the accessing process contains a dedicated instance os of class O in its heap memory from which it can correctly calculate the offset value using formula:

off(f)=(char *)&os.f−(char *)&os

In the following, it is assumed that the address of the dedicated object os is returned from a template function

template<class O> O *_s ( ) {. . . }

Therefore, the above formula can be rewritten as:

off(f)=(char *)&_{—}^{_{<O}}>( )−>−>f−(char *)_{—}s<O>( )

This formula uses the address &_<O>( )−>f which is correct because the accessing process is the process that created the os object in its process heap. As a result, the final off (f) value is also correct because it is calculated as f's offset, which is the same for any object of type O, including for an object o from shared memory. When a pointer p to object o is used instead of o, access is performed according to the following equivalent formula, defined as a C++ macro:

#define_{—}v(O, p, F, f) *(F *) ((char*)p+\((char*)&_{—}s<O>( )−>f−(char *)_{—}s<O>( ) ))

### Non-Virtual Method Call

Nonstatic methods expect their first implicit parameter to be this, which is used by the C++ runtime system in order to access fields and methods of the object pointed to by this. During such accesses, the fact that virtual tables reside in different process heaps causes runtime errors. To avoid these runtime errors, an additional parameter O *_this (a pointer to an instance of class O) is added to each non-constructor nonstatic method m ( ) of class O, the value of which is set to the address of the object o with respect to which the method m ( ) is to be invoked. At the same time, the method is invoked not on o, but on the dedicated object from the process heap os, as follows:

_{—}s<O>( )−>m(&o)

Each field or member-function access within m ( ) is construed as an explicit access through_this instead of an implicit or explicit access through this; such accesses follow the scheme so far described. For example, instead of accessing field f inside in ( ) as this−>f, the formula involving off (f) is used:

_v(O, _this, F, f)

Also, instead of calling a member method O::m2 ( ) inside m ( ), the following formula is used:

_{—}s<O>( )−>m2(_this)

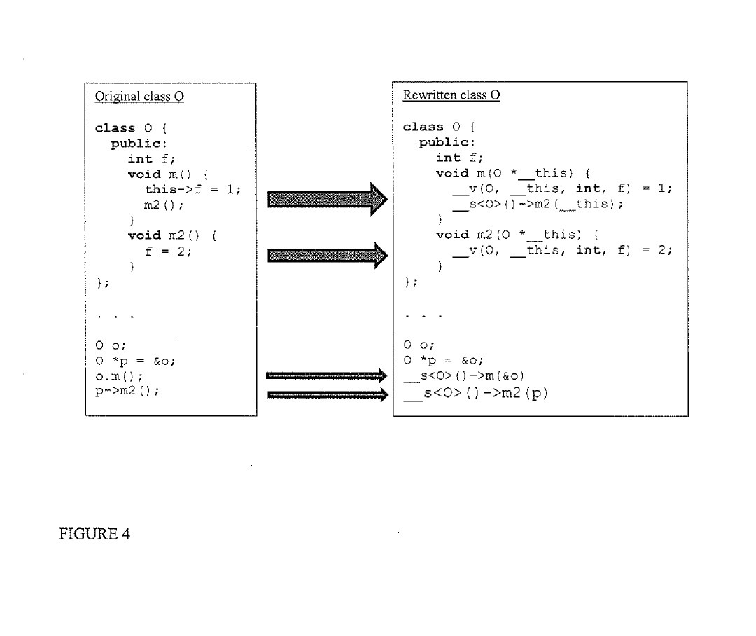

FIG. 4 shows how to rewrite a regular C++ member-function using the disclosed technique.

### Virtual Method Call-Simple Case

The above scheme for method calls does not work when virtual methods are called through a pointer or a reference to an object. Consider a pointer p to object o of type O and suppose that o is actually a part of a “bigger” object o2 of type O2 derived from O. In this case, o is a sub-object of the super-object o2. Also, suppose that both classes O and O2 define a virtual method m ( ). Then p−>m ( ) is actually calling m ( ) from the super-object o2 of type O2, not from the sub-object o of type O pointed to by p. This invocation is handled through the virtual tables of types O and O2. When the object o2 is in shared memory, a call p−>m ( ) may fail in case o2 had been created by a different process.

In order to correctly call O2::m ( ) through the pointer O *p, the Hello runtime calls m ( ) on the object_s<O2>( ) of type O2 allocated in each process heap. However, the runtime cannot pass pointer p for the parameter this to O2::m ( ) because_this is expected to point to the enclosing object o2 of type O2, not to the object o of type O to which p is pointing. Therefore, the runtime uses the fact that the offset between the enclosing and the enclosed objects are the same no matter where they are allocated—in shared memory or on the heap—and calculates thet offset from the heap object _s<O2>( ) using a dynamic cast to the super-class O as follows:

```
template<class O2, class O> int _off2( ) {
    return (char *)_s<O2>( ) −
          (char *)dynamic_cast<O>(_s<O2>( ));
        }
```

Then the runtime adds the calculated offset to p in order to get the address of the enclosing object o2. This addition is defined as a macro:

#define add(O2, O, p) (O2 *)((char *)p+_off2<O2, O>)

Finally, the runtime passes the resulting address as parameter_this to method m ( ). This results in the call

_{—}s<O2>( )−>m(_add(O2, O, p))

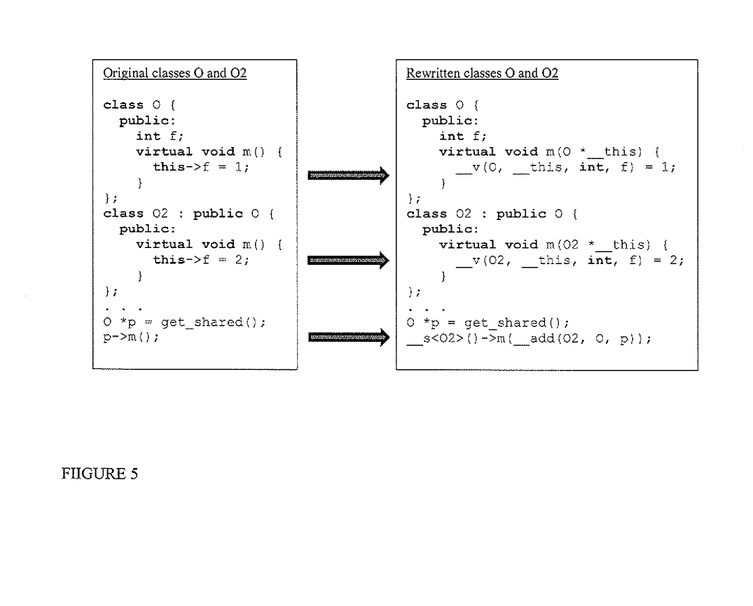

FIG. 5 shows how to rewrite a regular call to a C++ virtual member-function using the disclosed technique. The call uses function get_shared ( ) which returns pointer p of class O to an object o from shared memory. It is assumed that o is a sub-object of a larger object of class O2:

### Virtual Method Call-General Case

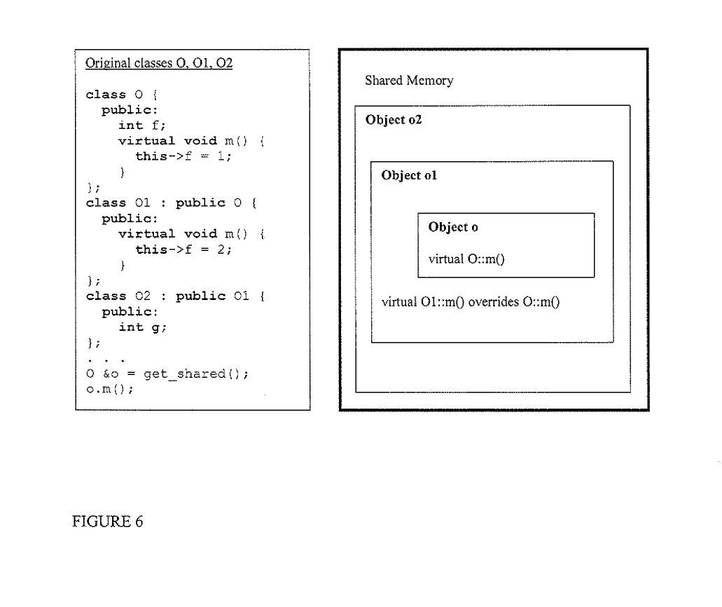

The scheme from the previous section will not work in the most general case when p points to an object o of type O, which is actually a sub-object of object o2 of type O2, but the virtual method O::m ( ) is overridden not in O2 but in some type O1 which is derived from O and is a base type for O2. This is because the_this pointer, as calculated above, points to o2, but needs to point to o1, which is a sub-object of o2 containing o. FIG. 6 shows the class hierarchy of O, O1 and O2.

For this case to work correctly, we use the fact that the offset from & o2 to &o can be calculated as the difference_off<O2, O> because the layout for each object of the same type are the same no matter where the object is instantiated is utilized. Therefore, more steps are performed when calling m ( ). The address of o2 is calculated as before and passed, converted to a pointer to char, as the first additional parameter of m ( ) named t. The new, second parameter of m ( ) named c is added to the signature of m ( ). The pointer_s<O2>( ) is passed to that parameter cast as a pointer to char. The correct value of_this is calculated by adjusting the first parameter, as the first statement of method m ( ), with the difference of

d=c−(char *)this

This adjustment works because, at runtime, this within m ( ) correctly points to a sub-object of class O1 of the object_s<O>( ) since it is calculated by C++ runtime using virtual tables for classes O, O1, and O2, which all reside in the heap of the process. Therefore, the call is performed as follows:

_{—}s<O2> ( )−>m((char *)_add(O2, O, p), (char *)_{—}s<O2>( ) )

The method m ( ) from class O1 is generated with the additional second parameter as described above and with an additional line at its beginning which calculates_this through the above-described adjustment:

```
void m(char *t, char *c) {
    int d = c − (char *)this;
    O1 *_this = (O1 *) (t − d);
    . . . .
}
```

Note that the nonstatic non-constructor methods of classes should be generated with the two additional parameters described above. This latest scheme is general enough to work for all the cases described in the previous sections. When two of the types O2 and O1 are the same and when all three types O2, O1, and O are the same because the respective offsets to sub-objects O1 and O all become nulls, the additional parameter c becomes the same as (char *) this, so the adjustment difference becomes 0. For similar reasons, this scheme also works in case the method called is not a virtual one, or when all O2, O1, and O are the same.

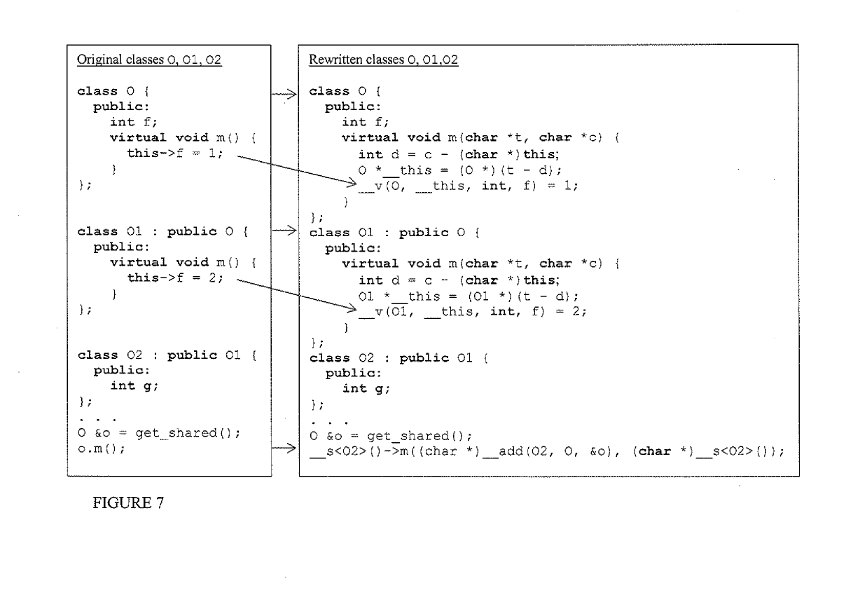

FIG. 7 shows how to rewrite a regular call to a C++ virtual member-function using the disclosed technique. It uses function get_shared ( ), which returns a ref of class O to an object o from shared memory. It is assumed that o is a sub-object of a larger object o2 of class O2 and that the method m ( ) is redefined in class O1, which is derived from O while O1 itself is a super-class of O2.

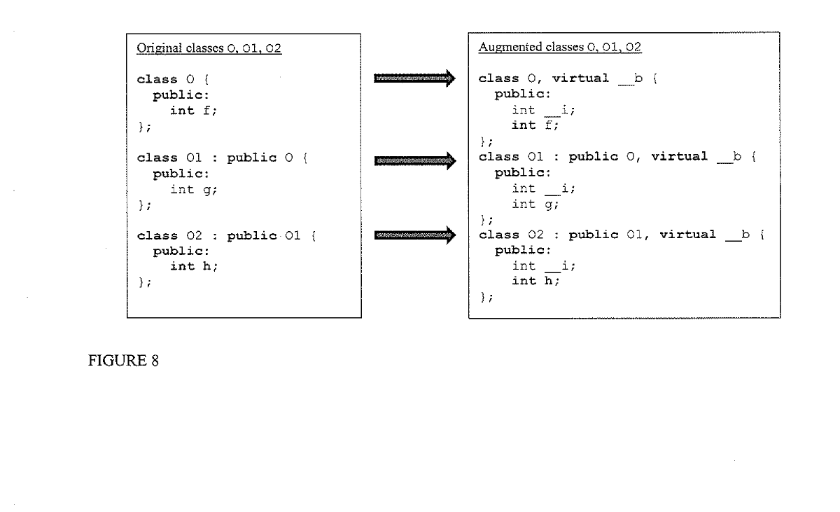

When the exact class name of the containing class is not known at compile time, each C++ class is augmented with a numeric field named_i, at runtime, a constructor of each derived class sets the field in all the sub-objects of the newly created object to the unique index of the most derived sub-class. FIG. 8 shows an example of the original and the augmented C++ classes.

Assuming that, at runtime, only the address p of an object of class O is known, the value of the field_i can be calculated using the macro_v (O, p, int, _i), which works correctly even for objects located in shared memory. This value uniquely indexes all C++ classes involved and is used, as described below, in order to invoke member-functions on the shared objects correctly. Note that accessing data fields do not require the knowledge of_i. Therefore, as before, the same macro_v (O, p, F, f) can be used for accessing any field f of type F from object *p of type O. Also, note that each class definition is augmented with the virtual base class _b. This is done in order to use the C++ dynamic cast mechanism when accessing sub-objects of the dedicated objects created on the process heap, as explained in the following subsection.

### Virtual Method Call

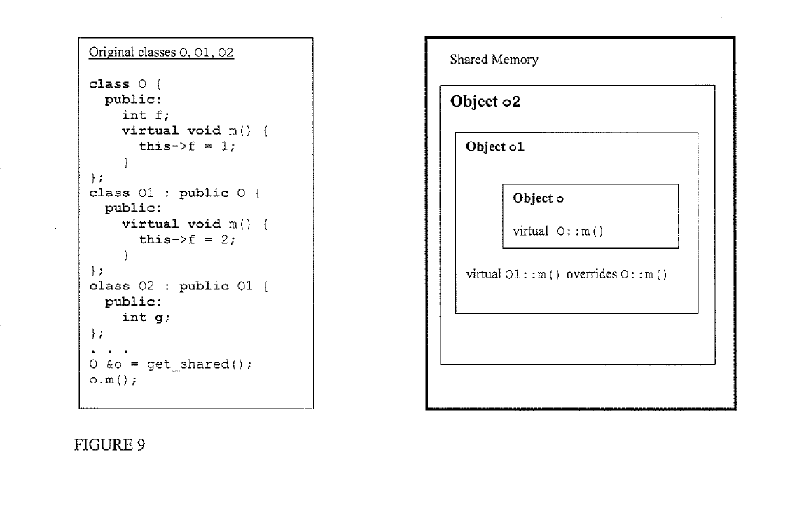

We now consider a general virtual method call using dynamic type information. Suppose when p points to an object o of type O, which is actually a sub-object of object o2 of type O2, the virtual method O::m ( ) is overridden not in O2 but in some type O1 which is derived from O and is a base type for O2. The formulae used here are general enough to cover the possible cases including non-virtual method calls, and possible arrangements in the class hierarchy (when O2==O1, or O1==O). FIG. 9 illustrates a general virtual method call.

First, observe that there is no need to change the conversion scheme for the member-function's signatures—it remains the same as it was for the static case. This is because the conversion involves only knowledge of the class where the member-function is defined. However, the call to a member function must be made differently because the exact class names O1 and O2 may not be known at runtime. For this purpose, a series of formulae is defined that allow for the correct dispatch of a member-function for an object located in shared memory.

The static call follows:

O &o=get_shared ( ); _{—}s<O2>( )−>m((char *)_add(O2, O, &o), (char *)_{—}s<O2>( ));

The template call_s<O2> and the class name O2 cannot be used, because O2 is not known at runtime. However, the first occurrence_s<O2>( )−> is replaced with _s<O>( )−> because O is a super-class of O2 and because the C++ runtime knows how to correctly dispatch m ( ) on the object_s<O> located in the heap of the process, so the above call is equivalent to

_{—}s<O>( )−>m((char *)_add(O2, O, &o), (char *)_{—}s<O2>( ));

Now we replace the last argument (char *)_s<O2>( ) with another expression that yields the same result from the known value of the field_i. This expression calls a specially defined static function

char *_t (int_i) {. . . }

This function returns the address of the dedicated object (created at startup on the process heap) of a class with index_i. Note that it is possible to write the body of this function since all classes and their indexes are known before compilation. Therefore, the original call expression is rewritten as:

_{—}s<O>( )−>m((char *)_add(O2, O, &o), _{—}t (_{—}v(O, &o, int, _{—}i)));

The resulting formula still has the first argument that depends on the name of the containing class O2. In order to eliminate O2, we note that macro_add ( ) calculates the address of object o2 located in shared memory knowing the class O2. The same value is calculated knowing the index_i of O2 from the object o according by:
1. First, get the address of the dedicated O2 object

char *do2a=t(v(O, &o, int, i));
2. Then get the address of the object's sub-object of the virtual base class b using statically defined function

_b *_ba(int_i) ( . . . )
This function returns address of the sub-object of class_b of the dedicated object (created at startup on the process heap) of a class with index_i. Note that it is possible to write the body of that function, since all classes and their indexes are known before compilation. Therefore, the address of the sub-object is calculated as:

_{—}b *do2ba=_{—}ba(_{—}v(O, &o, int, _{—}i));
3. From this address, the address of the sub-object of class O is obtained by applying a dynamic cast, which succeeds because it is applied to objects from the heap:

char *doa=(char *)dynamic_cast<O>(do2ba);
4. Knowing both addresses o2a and oa, the offset from any object of class O2 to the object's sub-object of class O is calculated by using the difference:

int off=do2a−doa;
5. Finally, the address of the object o2 is obtained from shared memory by adding this offset to the address of object o:

char *o2a=(char *)&o+off;

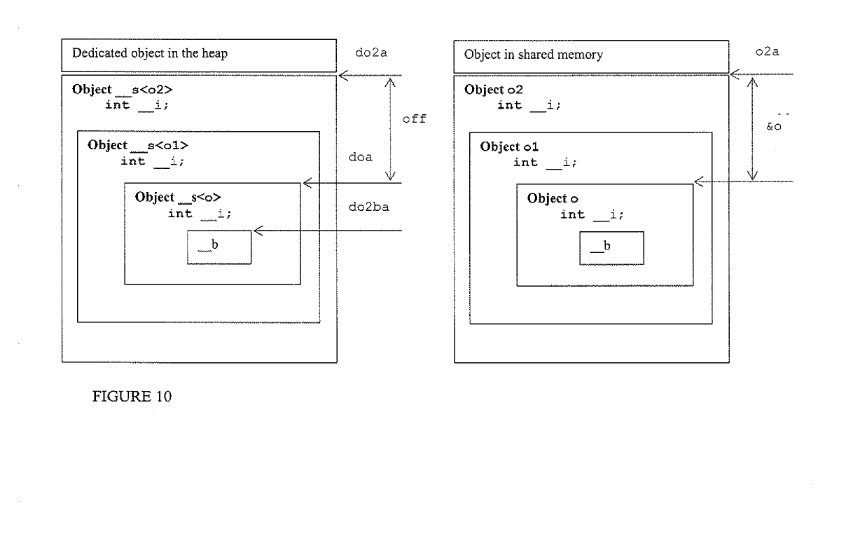

FIG. 10 shows graphically relations between a dedicated object and its sub-objects and the offsets calculated according to the disclosed method.

The above calculations can be summarized as a new template function_e (O, &o):

| template<class O> char *_e(O &o) { | | |
|---|---|---|
| char | *do2a | = _t(_v(O, &o, int, _i)); |
| _b | *do2ba | = _ba(_v(O, &o, int, _i); |
| char | *doa | = (char *)dynamic_cast<O *>(do2ba); |
| int | off | = do2a − doa; |
| char | *o2a | = (char *)&o + off; |

return o2a;
}

The first argument in the call to m ( ) is replaced as :

_{—}s<O>( )−>m(_{—}e(o), _{—}t(_{—}v(O, &o, int, _{—}i)));

Casting

The casting algorithm is based on the fact that the offset between an object of class O2 and the object's sub-object of class O1 is the same regardless where the object is located. Because of that, this offset can be calculated using regular C++ expressions that involve dedicated object_s<O2>( ) and its sub-object of class O1, then adding the offset to the address of an object located in the shared memory. This works for both down-cast and up-cast operations, for either static or dynamic casting.

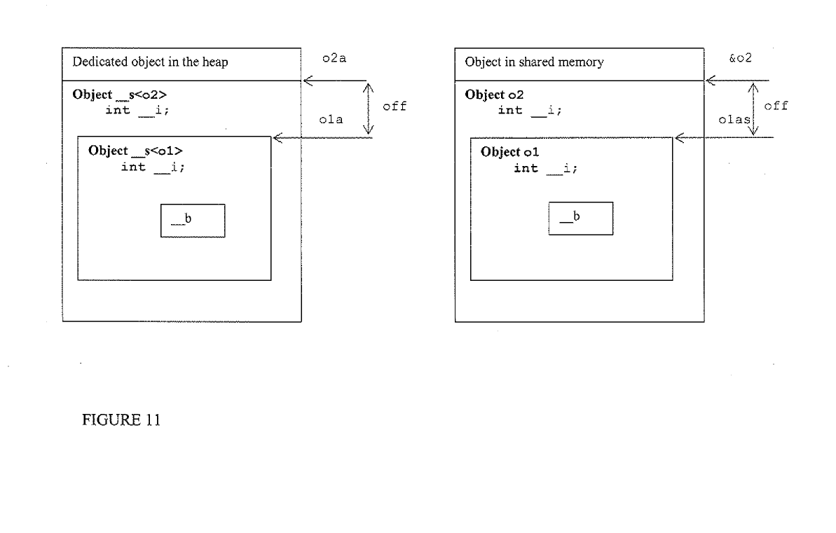

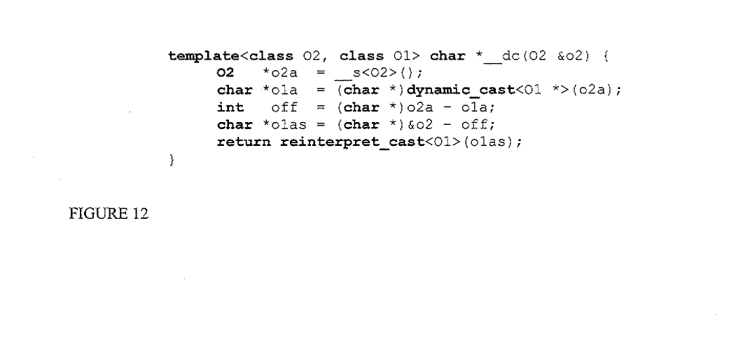

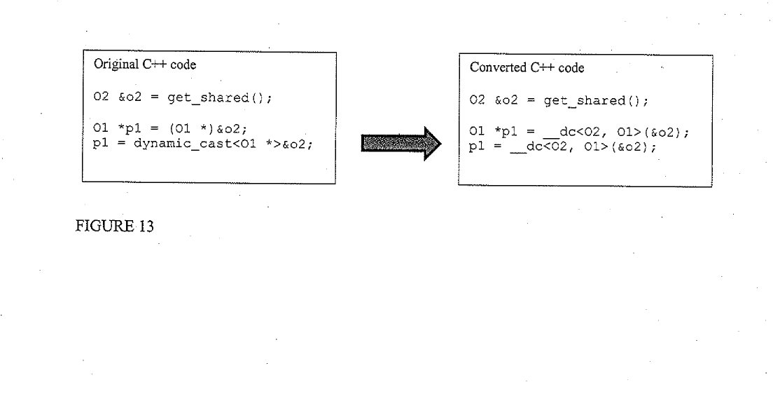

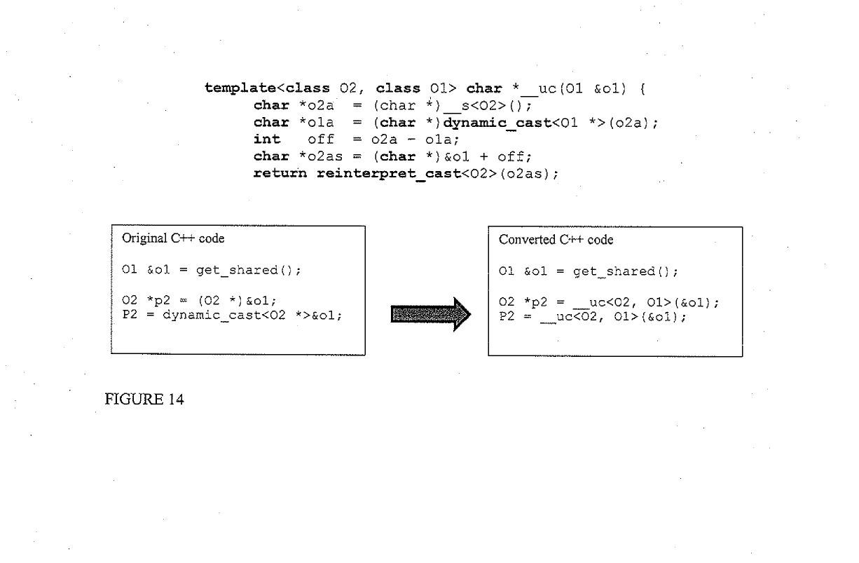

For the down-cast case, consider an object o2 of class O2 in the shared memory. This object is cast to its sub-object o1 of class O1 where O1 is a super-class of O2. FIG. 11 illustrates the disclosed casting method. For this purpose, a new template method is employed as shown in FIG. 12. The first line gets the heap address of the dedicated object for class O2. The second line gets the address of the object's sub-object of class O1. The dynamic cast is correct because o2a points to an object in the process heap. The third line calculates the difference between these two addresses. Finally, the fourth and fifth lines subtract that offset from the address of o2, casts it to class O1, and returns the result as the address of the sub-object o1 of object o2. FIG. 13 illustrates conversion for C++ down-casts of objects from shared memory. The up-cast ease works in the same manner, except the offset shall be not subtracted but added to the address of the shared object. FIG. 14 illustrates conversion for C++ down-casts of objects from shared memory.

Use Cases

The above methods are applicable in the context of C++ application that accesses objects located in shared memory from different processes. In particular, the methods can be utilized as follows:
1. Manual conversion of regular C++ expressions according to the described method can be done when the amount of such conversion is not too big.
2. Automatic conversion of all or some C++ expressions using a specially written preprocessor that transforms regular C++ expressions according to the described methods can be made when the amount of conversion exceeds the limited efficiency of manual conversion.
3. Another use case is when an application is written not in C++, but in some other object-oriented language H by which programs access objects located in shared memory, and sources of which are translated into C++ prior to building an executable. In this case the described access methods can be utilized in the H to C++ translator, assuming that the type hierarchy from H can be closely mapped into the class hierarchy from C++, and that H access expressions can be closely mapped into C++ expressions.
   The last two cases are especially amenable to the full automation of the proposed methods because the C++ preprocessor or the H-to-C++ translator can generate the initial code that creates dedicated objects. They can also generate the auxiliary templates and macros, add additional fields into the object layout, and convert the relevant access expressions for fields, functions and casts. Also note that the particular conversions can be changed for better efficiency and convenience using either a manual or an automated method. In particular, instead of two additional address parameters, one context parameter that holds the two addresses can be added. Instead of specific macros and templates, static functions dispatched on the class index value can be used, etc.

Although the present invention has been described in terms of particular embodiments, it is not intended that the invention be limited to these embodiments. Modifications within the spirit of the invention will be apparent to those skilled in the art. For example, many different implementations of the disclosed methods and systems can be obtained by varying any of many different implementation and design parameters, including modular organization, programming language, operating system, computer-hardware platform, data structures, control structures, and many other such parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method for accessing objects stored in shared memory, the method comprising:
placing instances of the objects in process heap memory; and
using offsets calculated using the instances of the objects in process heap memory to calculate offsets for similar objects in shared memory.
